(19) United States
(12) Patent Application Publication
(10) Pub. No.: US 2002/0044158 A1
(43) Pub. Date: Apr. 18, 2002

(54) System for storing and retrieving electronic sheet music

(76) Inventors: C. Alan Peyser, Bethesda, MD (US); James R. Taft, Cabin John, MD (US)

Correspondence Address: Finnegan, Henderson, Farabow, Garrett & Dunner, L.L.P., 1300 I Street, N.W., Washington, DC, 20005-3315, US

(21) Appl. No.: 09/932,933

(22) Filed: Aug. 21, 2001

Related U.S. Application Data
(60) Provisional application No. 60/226,558, filed on Aug. 21, 2000.

(51) Int. Cl. G05B 15/00

(52) U.S. Cl. 345/700; 700/1

(57) ABSTRACT

Methods and systems consistent with certain principles related to the present invention enable a portable computer device to retrieve, store and display electronic sheet music. The portable computer device may access electronic sheet music directly or indirectly from a Web server that provides the sheet music. The portable computer device may store the accessed sheet music locally for displaying on a display. The lighting level of the display may be adjusted by a user such that the user may view the sheet music under various ambient light conditions. Also, the portable computer device includes a page turner that is controlled by the user's foot. The page turner may allow the user to scroll through images of the sheet music presented on the display using their foot, thus allowing the user to use their hands for other purposes, such as playing an instrument.

### PRIORITY APPLICATION

This application claims the benefit of U.S. Provisional Application No. 60/226,558, filed Aug. 21, 2000, which is hereby incorporated by reference in its entirety.

### DESCRIPTION OF THE INVENTION

Field of Invention

The present invention relates to a data processing system and, more particularly, to an electronic page turning system consistent with the present invention enables users to obtain, store, transport, and retrieve information corresponding to sheet music.

Background of Invention

Musicians generally rely on sheet music to learn and to play music. Sheet music generally consists of a musical score or a series of notes written on paper.

Experienced musicians can accumulate significant collections of sheet music. Often times, as the collection grows it can be difficult to maintain and to organize such that the musician can retrieve a specific piece of sheet music without a significant amount of effort. Also, because of the importance of such a collection and the nature of it (i.e., paper), the musician develops a concern that a destructive force such as a fire could eliminate years of work in developing the collection.

Collecting sheet music can also be a difficult task. It is often necessary to search many suppliers to find a particular piece of sheet music.

Some, musicians also rely on sheet music during performances. Because of the nature and size of the sheet music, however, it can be difficult to turn the pages of a particular piece of sheet music while playing an instrument during a performance. This is particular true when the score provides few pauses for the musician.

There is therefore a need for a system that enables users to store sheet music efficiently, and to improve the retrieval process for sheet music, while eliminating concerns that the sheet music may be lost to a destructive force. Such a system may also facilitate the process of collecting sheet music. Additionally, such a system may make it easier for musicians to refer to sheet music during performances.

### SUMMARY OF THE INVENTION

Methods and systems consistent with features of the present invention enable a computer device to be configured with components that allow access to sheet music in electronic form for presentation on a display. The computer device may include memory for storing the sheet music and a display for presenting the sheet music to a user. The computer device may also include a display control component that allows a user to control the lighting of the display such that the sheet music may be adequately viewed in various ambient light conditions. Furthermore, the computer device may include a metronome control component that allows the user to control a metronome sound produced by the computer device. Additionally, the computer device may include a page turner component that allows a user to scroll through the sheet music presented on the display. The page turner component may be configured to be controlled by a user's foot, thus allowing the user the use of his/her hands while operating the computer device.

Additional configurations consistent with certain principles related to the present invention will be set forth in part in the description which follows, and in part will be obvious from the description, or may be learned by practice of methods, systems, and articles of manufacturer consistent with features of the present invention. The configurations consistent with certain principles related to the present invention will be realized and attained by means of the elements and combinations particularly pointed out in the appended claims. It is to be understood that both the foregoing general description and the following detailed description are exemplary and explanatory only and are not restrictive of the invention as claimed.

### BRIEF DESCRIPTION OF THE DRAWINGS

The accompanying drawings, which are incorporated in and constitute a part of this specification, illustrate several configurations consistent with certain principles related to the present invention and together with the description, serve to explain the principles of the invention. In the drawings,

FIG. 1 illustrates an exemplary system environment, consistent with it features and principles of the present invention;

FIG. 2 illustrates an exemplary intermediate computer device, consistent with features and principles of the present invention;

FIG. 3 illustrates an exemplary M-Book, consistent with features and principles of the present invention; and

FIG. 4 illustrates exemplary components of an M-Book, consistent with features and principles of the present invention.

### DETAILED DESCRIPTION

Methods and systems consistent with features and principles of the present invention enable a computer device to be configured with various components that allow a user to access electronic sheet music and control its presentation on a display.

Methods and systems consistent with features of the present invention may perform functions by configuring a computer device with a receiver component that may access sheet music that is in electronic form. The computer device may store the electronic sheet music locally in a memory. The computer device may present the electronic sheet music on a display such that music may be viewed by a user. The computer device may also include a display controller that allows a user to selectively adjust the lighting of the display. The computer device may also include a metronome controller for allowing the user to selectively control a metronome sound produced by the computer device. Additionally, the computer device may include a page turner controller that allows a user to use his/her foot to scroll through the sheet music as it is displayed on the display.

Reference will now be made in detail to the exemplary configurations consistent with certain principles related to the present invention, examples of which are illustrated in the accompanying drawings. Wherever possible, the same reference numbers will be used throughout the drawings to refer to the same or like parts.

The above-noted features and principles of the present invention may be implemented in various environments. Such environments and related applications may be specially constructed for performing the various processes and operations of the invention or they may include a general purpose computer or computing platform selectively activated or reconfigured by program code to provide the necessary functionality. The processes disclosed herein are not inherently related to any particular computer or other apparatus, and may be implemented by a suitable combination of hardware, software, and/or firmware. For example, various general purpose machines may be used with programs written in accordance with teachings of the invention, or it may be more convenient to construct a specialized apparatus or system to perform the required methods and techniques.

The present invention also relates to computer readable media that include program instruction or program code for performing various computer-implemented operations based on the methods and processes of the invention. The program instructions may be those specially designed and constructed for the purposes of the invention, or they may be of the kind well-known and available to those having skill in the computer software arts. Examples of program instructions include for example machine code, such as produced by a compiler, and files containing a high level code that can be executed by the computer using an interpreter.

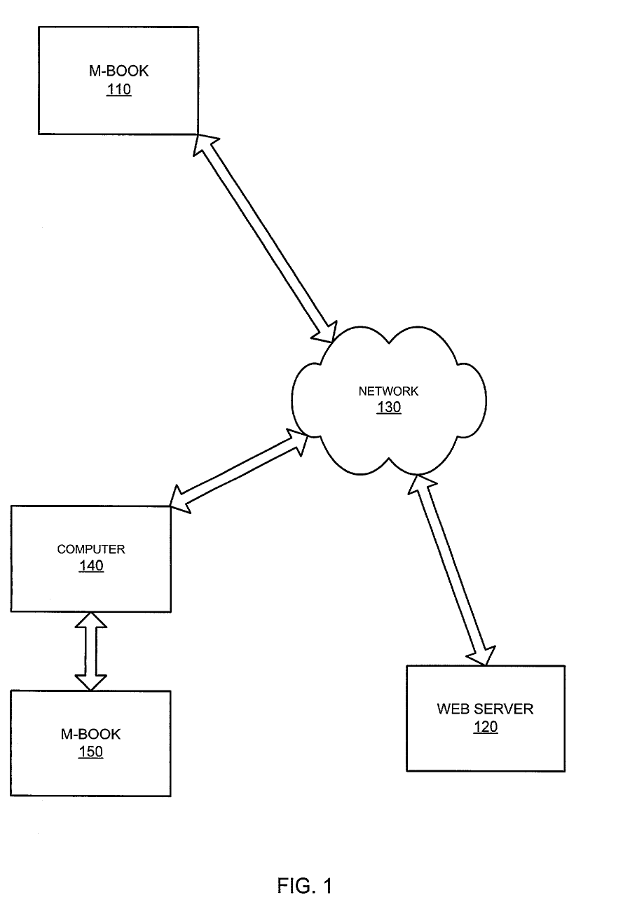

Systems and methods consistent with certain principles related to the present invention enable the receipt, storage, retrieval, and display of stored information corresponding to music sheets. Sheet music may be associated with one or more hard copies of one or more music scores printed on paper, or other similar products used for presenting textual and/or graphical information. As shown in FIG. 1, one implementation of a system consistent with the present invention includes M-Books 110, 150, M-Book Server 120, network 130, and computer 140. M-Books 110, 150 may include a desktop computer, workstation, laptop, personal digital assistant or any other similar computer system known in the art. For example, M-Books 110, 150 may include a processor, associated memory, and numerous other elements and functionalities available in computer systems (not shown). These elements may include input/output devices, such as a keyboard, touchscreen, mouse and display (not shown), although these input means may take other forms. In one configuration consistent with certain principles related to the present invention, M-Books 110, 150 may be personal computers embodied in single unit form factor with a display screen, for example, a screen large enough to view at least one sheet of music. The personal computer may include memory such as ROM, RAM, and secondary storage. Stored in the memory is an operating system and an M-Book application. The M-Book application uses standard operations of the operating system to store, retrieve, and display information from the memory.

As shown, M-Books 110, 150 may be connectable to the M-Book Server 120 via network 130. Network 120 may include one or more communication networks, including the Internet or any other similar network that supports Web-based processing. As shown, M-Book 110 may be connected directly to network 130, while M-Book 150 may be connected to network 130 via an intermediate computer 140. Computer 140 may be a computer system configured to exchange information between M-Book 150 and network 130, such as a local server computer system, or gateway computer system. Under both configurations, a user may store sheet music in electronic form in the memory of M-Book 110, 150. The electronic sheet music stored in M-Book 110, 150 may originate from M-Book Server 120 or intermediate computer 140. For example, a user operating 110, 150 may access M-Book Server 120 using a browser such as Netscape Navigator from Netscape Communications Corporation running on M-Book 110, 150 or intermediate computer 140 (if M-Book 150 is utilized). In either configuration, the user can download sheet music in electronic form from M-Book Server 120 and store it in M-Book 110, 150. A transaction fee may be charged to the user using known electronic commerce techniques. For instance, the user may be assigned a payment identifier that allows the user to be charged fees based on the downloaded sheet music.

The configuration of FIG. 1 is exemplary and is not intended to be limiting. That is, one skilled in the art would realize that any number of system and network configurations may be employed by methods and systems consistent with features of the present invention, without departing from the scope of the present invention. Furthermore, the exemplary software described above is not intended to be limiting. One skilled in the art would realize that any number of browser applications, or other forms of network communication software, may be employed by methods and systems consistent with features of the present invention, without departing from the scope of the present invention.

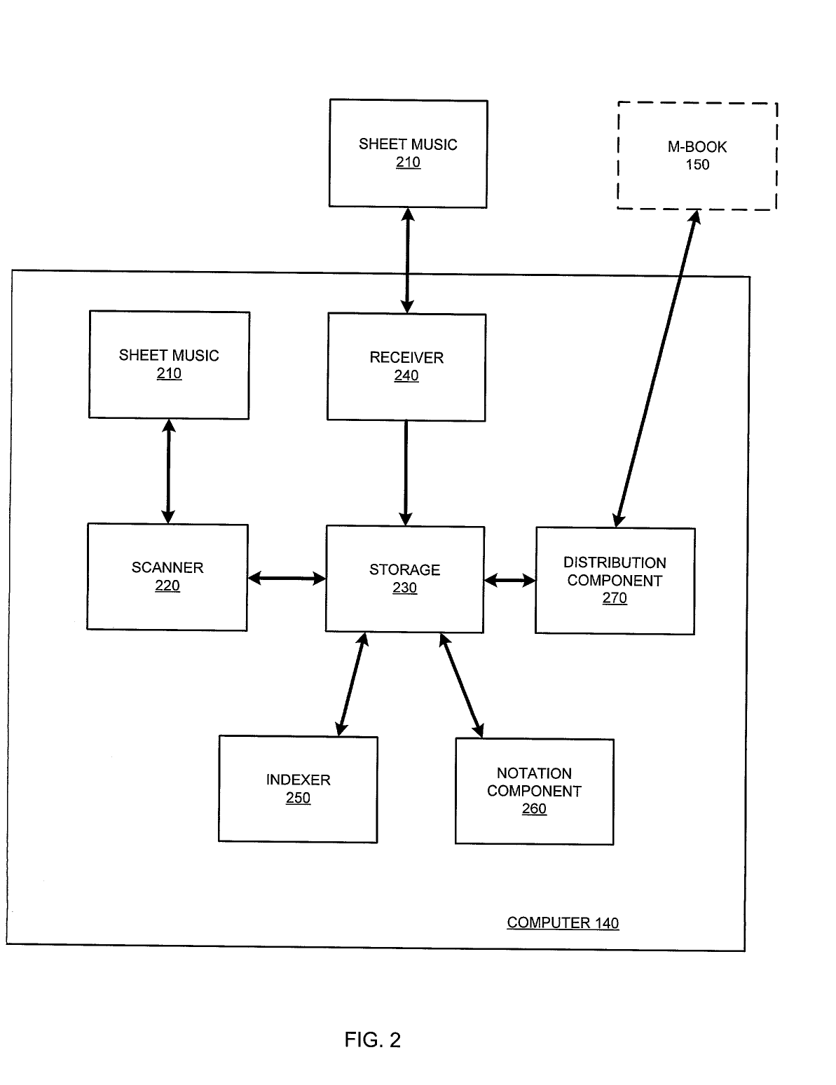

FIG. 2 illustrates various components of intermediate computer 140 consistent with certain principles related to the present invention. As shown, sheet music 210 maybe scanned using a conventional scanner 220 and stored in a storage 230. A receiver 240 may also be used to obtain sheet music 210 in electronic form from a source such as M-Book Server 120. Receiver 240 may be a wireless or wired component. For example, a wireless or wired modem may be used to connect computer 140 to network 130 to download sheet music 210 in electronic form for storage in storage 230. Computer 140 may also include a display for viewing sheet music and a printer for printing (both not shown).

In one configuration consistent with certain principles related to the present invention, computer 150 may also have as part of the M-Book application software an indexer 250, notation component 260, and distribution component 270. Indexer 250 may be used to index the electronic sheet music for retrieval. For example, indexer 250 may create a simple title-based index that permits the user to retrieve the stored electronic sheet music by entering a music title. Alternatively, a more complex indexer 250 may be used to permit the user to retrieve the stored electronic sheet music using an aspect of the music itself, for example, a note or series of notes. One skilled in the art would recognize that a variety of indexing techniques may be employed by methods and systems consistent with features of the present invention, and such techniques are not limited to the examples described above.

Notation component 260 may permit the user to add notations to be stored with the electronic sheet music. In this way when a user retrieves a particular work for display on computer 140 or M-Book 150, related notations may also be displayed on command. For example, the software application permits the user to identify a specific note or series of notes within a work and to add and store a related electronic notation. The notation may appear automatically or on command when the user accesses the electronic sheet music.

Distribution component 270 may be used to load electronic sheet music from computer 140 onto the M-Book 150. Those skilled in the art will recognize that other configurations may be possible within the scope of the invention. For example, receiver 240 be included within M-Book 110, 150 itself, or scanner 220 may be connected directly to M-Book 110, 150. In this configuration indexer 250 and notation component 260 may be included within the M-Book software application and there would be no need for the distribution component unless the user also wanted to be able to transfer electronic sheet music from M-Book 110, 150 to another device.

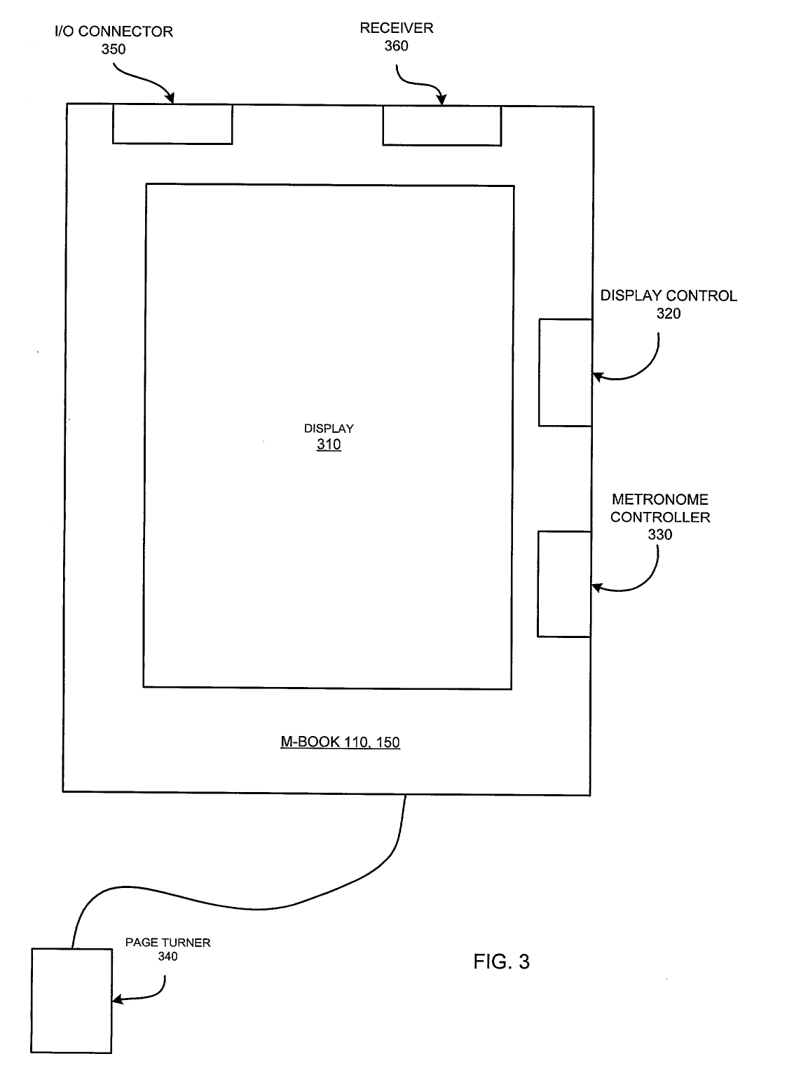

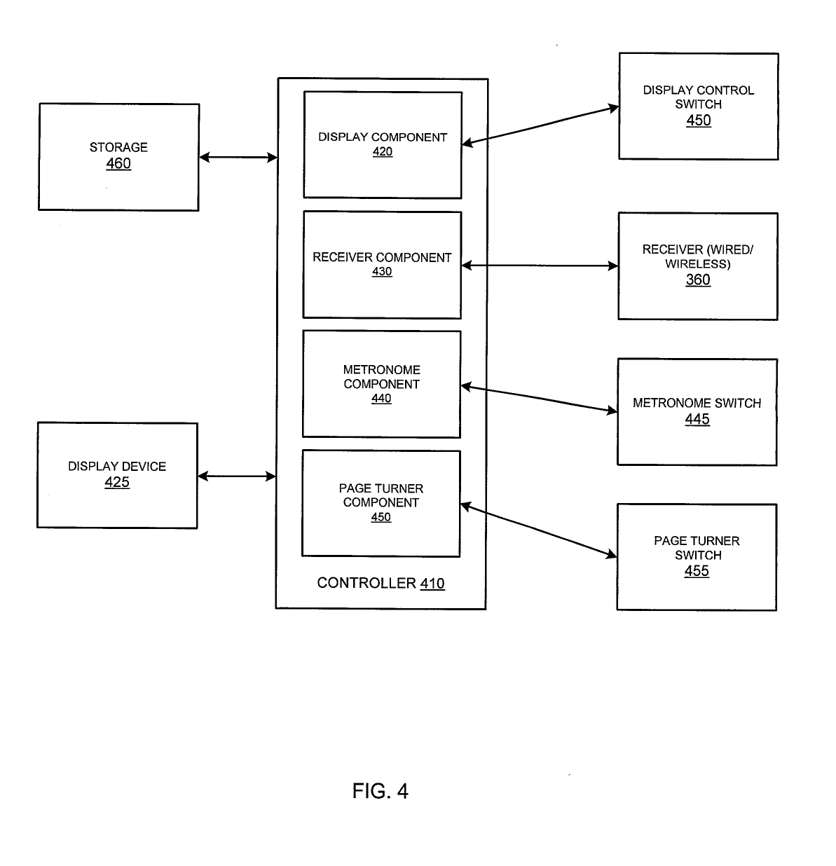

FIGS. 3 and 4 illustrate one example of M-Book 110, 150 in a manner consistent with certain principles related to the present invention. As shown in FIG. 3, M-Book 110, 150 may comprise a flat panel display 310 preferably capable of displaying at least one sheet of music in a manner similar to a physical sheet of music. Although display 310 may be configured to display a standard sized sheet of music, one skilled in the art would recognize that sheet music is also published using more conventional sizes such as 8½×11, A4, etc. Accordingly, methods and systems consistent with features of the present invention may configure display 310 to accommodate the display of these various sizes of sheet music without departing from the scope of the invention. M-Book 110, 150 may also comprise a display control 320, metronome controller 330, and a page turner 340. M-Book 110, 150 may also include an I/O connector 350 and a receiver 360. Display control 320 and metronome controller 330 may be hardware or software, with the display control 320 handling aspects of lighting the flat panel display and the metronome controller 330 handling control of an output sound similar to the sound of a metronome. Display control 320 permits the user to modify the output light of display 310 under various lighting conditions. For example, the user may wish to have the display at different levels for a room with overhead lighting versus an orchestra pit with poor lighting. In one configuration consistent with certain principles related to the present invention, display control 320 may include preset positions associated with the various lighting conditions. A user may set the positions based on various known lighting conditions. For example, display control 320 may be associated with a preset position for an indoor orchestra performance, and another for outdoor performance. The user may select the position based on the lighting condition, and M-book 110, 150 may automatically adjust the lighting of display 310 to the pre-selected level. Also, M-Book 110, 150 may be configured to allow the user to store lighting conditions associated with specific locations. That is, the user may define lighting conditions associated with physical performance locations, such as the Kennedy Center in Washington, D.C. This way, the user may select the location stored within M-Book 110, 150 they are to perform at, and display 310 may be automatically adjusted to the defined lighting conditions associated with the selected location. Alternatively, Web server 120 and/or computer 140 may maintain current predetermined optimum lighting conditions for selected performance locations in a database. M-Book 110, 150 may be configured to download the stored lighting conditions when needed.

The sound for the electronic metronome may be output from a speaker (not shown) in M-Book 110, 150. Alternatively, M-Book 110, 150 may be equipped with a speaker headset that enables a user to listen to the sound controlled by metronome controller 330. The headset may be configured in a wired or wireless format.

Page turner 340 is a device connectable to the M-Book for turning pages of the electronic sheet music. Page turner 340 may take various forms. In one configuration consistent with certain principles related to the present invention, page turner 340 may be configured such that it permits the ability to scroll pages of sheet music one at a time or multiple pages using a foot. Page turner 340 may include various control components, such as a button that may be used for scrolling one page at a time downward through a work comprised of multiple electronic sheets of music, and another button for scrolling upward. Also, page turner 340 may include a button that allows a user to flip to a page, backward or forward, a predefined range of pages. In another configuration consistent with certain principles related to the present invention, page turner 340 may also include a scrolling wheel like that found on the Microsoft Intelligent Mouse only bigger so it can be operated by foot movement.

I/O connector 350 may be used to connect various input and output devices to M-Book 110, 150, including a mouse and keyboard for input and a printer for output. Receiver 350 may be optional and it may take the form of a wireless modem. M-Book 110, 150, when equipped with receiver 350, may be used to access electronic music stored remotely. For example, a user can access remote electronic sheet music during a concert.

FIG. 4 shows an exemplary software application, referred to as a controller 410, that may be equipped within M-Book 110, 150. Controller 410 may comprise a display component 420, receiver component 430, metronome component 440, and page turner component 450. Each of these components may control the functions perform by the corresponding hardware or software component explained in connection with FIG. 3 above. In one configuration consistent with certain principles related to the present invention, controller 410 may be connected to display control unit 425, receiver 360, a metronome switch 445 a page turner switch 455, a display control switch 450, and storage 460.

Display control unit 425 may be a software and/or hardware (or a combination thereof) that controls display 310 for presenting information, such as sheet music. Metronome switch 445 may be software and/or hardware (or a combination thereof) that interfaces with metronome controller 330 and controller 410 for processing metronome related functions consistent with features of the present invention. Page turner switch 455 may be software and/or hardware (or a combination thereof) that interfaces with controller 410 and page turner 340 for processing page turning functions related to features consistent with the present invention. Display control switch 450 may be hardware and/or software (or a combination thereof) that interfaces controller 410 and display control 320 for processing the display functions consistent with features of the present invention. Storage 460 may be a local memory within M-Book 110, 150 that stores the sheet music displayed on display 310.

The foregoing description of an implementation of the invention has been presented for purposes of illustration and description. It is not exhaustive and does not limit the invention to the precise form disclosed. Modifications and variations are possible in light of the above teachings or may be acquired from practicing of the invention. For example, the described implementation includes software but the present invention may be implemented as a combination of hardware and software or in hardware alone. The scope of the invention is defined by the claims and their equivalents. Furthermore, the configuration shown in FIGS. 1-4 are not intended to be limiting. One skilled in the art would recognize that any number various configurations may be employed by methods and systems consistent with features of the present invention, without departing from its scope. For example, M-Book 110, 150, as shown in FIG. 3 may be configured with various other controls that a user may use for viewing sheet music.

In one configuration consistent with certain principles related to the present invention, M-Book 110, 150 may be configured to display an animated graphic (or video) of a conductor that follows a music score as it is played. The animated graphic may be stored with the electronic sheet music and executed in sequence with the metronome controller such that display 310 presents a window including the animated graphic. Also, a user may view a conductor while reading the sheet music presented in display 310. The animated graphic may be live video fed into M-Book 110, 150 through I/O connector 350. For example, an orchestra including a number of musicians and a conductor, each equipped with an M-Book 110, 150, may be connected to a video link that is connected to a video device that records the conductor during a musical performance. In this manner, live video associated with the conductor may be presented on display 310 while the orchestra performs, thus allowing the musicians to read the sheet music displayed on display 310 of each M-Book and view the conductor simultaneously.

Furthermore, in one configuration consistent with certain principles related to the present invention, a Global Positioning Satellite (GPS) module may be included with M-Book 110, 150. The GPS module may allow a user to assign a lighting level to a particular location, such as a specific performance location such that when M-Book 110, 150 is operated at the particular location, the assigned lighting level will automatically be provided in display 310 without user intervention.

Additionally, although configurations of the present invention are described as being associated with data stored in memory and other storage mediums, one skilled in the art will appreciate that these configurations can also be stored on or read from other types of computer-readable media, such as secondary storage devices, like hard disks, floppy disks, or CD-ROM; a carrier wave from the Internet; or other forms of RAM or ROM. Accordingly, the invention is not limited to the above described configurations of the invention, but instead is defined by the appended claims in light of their full scope of equivalents.

We claim:

1. A music sheet storage, retrieval, and display system comprising:
a storage configured to store sheet music in electronic form;
a display device configured to display images representing the stored sheet music under varying lighting conditions; and
a page turner switch connectable to a page turner with a foot control configured to permit a user to page through the images.

2. The system of claim 1, farther comprising:
means for retrieving the stored sheet music and displaying the stored sheet music as at least one image on the display device.

3. The system of claim 1, further comprising:
a display control configured to selectively adjust a level of lighting in the display device.

4. The system of claim 3, wherein the display control includes one or more positions reflecting predetermined lighting levels.

5. A method for storing, retrieving and displaying sheet music, comprising:
accessing a Web server to select an item of sheet music stored in electronic form;
providing a payment identifier of a user;
downloading a file containing the selected item into a storage of a portable page turning device configured to display images representing the stored sheet music under varying lighting conditions and in response to signals from a page turner with a foot control configured to permit a user to scroll through the images; and
charging a payment for the selected item from an account corresponding to the payment identifier.

6. The method of claim 5, wherein the Web server is accessed by a intermediate computer and the step of downloading comprises:
downloading the file from the intermediate computer to the portable page turner device.

7. The method of claim 5, further comprising:
creating an index associated with the selected item; and
directly accessing a portion of the selected item based on the index.

8. The method of claim 5, further comprising:
creating a notation associated with a portion of the selected item;
receiving a request to display the portion of the selected item; and
displaying the selected portion and the notation on a display included with the portable page turning device.

9. The method of claim 8, further comprising:
adjusting the lighting of the display based on input from a user.

10. The method of claim 8, further comprising:
automatically adjusting the lighting of the display based on the physical location of the portable page turning device.

11. A system for retrieving, storing, and displaying sheet music, comprising:
a unit for providing one or more stored images representing sheet music; and
a portable unit for retrieving the one or more stored images, displaying the one or more stored images in a display, adjusting a lighting level of the display based on user input; adjusting a rhythmic sound produced by a speaker based on user input, and providing the user input using a foot controlled page turner.

12. The system of claim 11, wherein the unit is a computer comprising:
a receiver for receiving the one or more images over a network,
a storage for storing the received one or more images,
an indexer for creating one or more indexes in selected portions of the one or more images based on user input,
a notation component for creating one or more notations in other selected portions of the one or more images based on user input, and
a distribution component for distributing the stored one or more images from the storage to the portable unit.

13. The system of claim 11, wherein the unit is a server remotely located from the portable unit.

14. The system of claim 12, wherein the receiver receives the one or more images from a server remotely located from the computer and the portable unit.

15. The system of claim 11, wherein the portable computer is configured to adjust the lighting level of the display based on a lighting level selection.

16. The system of claim 15, wherein the selection is provided by a user through a display control located on the portable computer.

17. The system of claim 15, wherein the selection is provided automatically by the portable computer.

18. The system of claim 11, wherein the foot controlled page turner includes a scrolling control that allows the user to scroll through the one or more displayed images.

19. A system for storing, retrieving and displaying sheet music, comprising:
means for accessing a Web server to select an item of sheet music stored in electronic form;
means for providing a payment identifier of a user;
means for downloading a file containing the selected item into a storage of a portable page turning device configured to display images representing the stored sheet music under varying lighting conditions and in response to signals from a page turner with a foot control configured to permit a user to scroll through the images; and
means for charging a payment for the selected item from an account corresponding to the payment identifier.

20. The system of claim 19, wherein the Web server is accessed by a intermediate computer and the step of downloading comprises:
means for downloading the file from the intermediate computer to the portable page turner device.

21. The system of claim 19, further comprising:
means for creating an index associated with the selected item; and
means for directly accessing a portion of the selected item based on the index.

22. The system of claim 19, further comprising:
means for creating a notation associated with a portion of the selected item;
means for receiving a request to display the portion of the selected item; and
means for displaying the selected portion and the notation on a display included with the portable page turning device.

23. The system of claim 22, further comprising:
means for adjusting the lighting of the display based on input from a user.

24. The system of claim 22, further comprising:
means for automatically adjusting the lighting of the display based on the physical location of the portable page turning device.
